(19) United States
(12) Patent Application Publication
(10) Pub. No.: US 2008/0198007 A1
(43) Pub. Date: Aug. 21, 2008

(54) Wirelessly-controlled detecting device

(76) Inventor: Tu Chi-Jung, Kaohsiung City (TW)

Correspondence Address: TROXELL LAW OFFICE PLLC, SUITE 1404, 5205 LEESBURG PIKE, FALLS CHURCH, VA, 22041, US

(21) Appl. No.: 11/707,243

(22) Filed: Feb. 16, 2007

(51) Int. Cl. G08B 21/00; G08B 17/00

(52) U.S. Cl. 340/540; 340/584; 340/603; 340/632; 340/870.16

(57) ABSTRACT

A wireless-controlled detecting device includes a one-way waterproof-ventilating outer layer installed therein with a signal detector provided with a programmable IC and a sensor module. The programmable IC and the sensor module are connected and fixed in position by a soft PCB that is connected with a thin power supply unit. The wirelessly controlled detecting device is further installed with a wireless transmitter and a wireless receiver for receiving the result of detection, and the wireless signal receiver is connected with a signal-indicating device for indicating the result of detection by means of lamplight, sounds, characters and vibration. The detection data can be stored in a storage device for a user to be controlled and managed.

### BACKGROUND OF THE INVENTION

1. Field of the Invention

This invention relates to a wirelessly-controlled detecting device, particularly to one provided with a soft PCB for circuit arrangement and various independent sensor modules to be selected and installed for use by a user himself to carry out timely detection according to the parametric variation of an environment, and also provided with a wireless transmitter and a wireless receiver for carrying out signal transmission.

2. Description of the Prior Art

Generally, a conventional detecting device is provided with a hard PCB and wires for connecting the hard PCB and its elements by welding; therefore, the wires are easy to be broken and disconnected from the elements, resulting in high fault ratio and short service life of products. In addition, the hard PCB will consume a lot of electricity and it is necessary to arrange additional system circuit for transmitting the detected data of the environment, thus wasting much time and increasing cost. Moreover, the solder used for welding is likely to release lead and other heavy metallic materials, which will make a person feel uncomfortable and also cause serious pollution to the environment.

### SUMMARY OF THE INVENTION

The objective of this invention is to offer a wirelessly controlled detecting device, able to lessen pollution, prolong the service life of products and lower cost in arrangement of the system circuit.

The wirelessly controlled detecting device in the present invention includes a one-way waterproof-ventilating outer layer installed inside with a signal detector provided with a programmable IC and a temperature, or humidity, gas, light, pressure or electric current signal sensor. The programmable IC and the sensor are connected and fixed in position by means of a soft PCB, which is able to be wound and extended and which also connects a thin power supply unit with a wireless signal emitter. The thin power supply unit supplies the detecting device with electric power to enable the elements in the one-way waterproof-ventilating outer-layer to operate, and the soft PCB can be extended out of the outer layer for expanding the detection range and target.

The wirelessly controlled detecting device of this invention is further provided with a wireless receiver for receiving the signal transmitted by the wireless transmitter. The wireless signal receiver is connected with a temperature, humidity, gas, light, pressure or electric current signal indicating device, which, after receiving the electric signal coming from the wireless receiver, will indicate the detection result by means of lamplight, sounds, characters or vibration, and such detected results can be stored in a data storage device to be controlled and managed.

### BRIEF DESCRIPTION OF DRAWINGS

This invention will be better understood by referring to the accompanying drawings, wherein:

FIG. 1 is a front view of a wirelessly-controlled detecting device in the present invention; and

FIG. 2 is a flow chart of an operating process of the wirelessly-controlled detecting device in the present invention.

### DETAILED DESCRIPTION OF THE PREFERRED EMBODIMENT

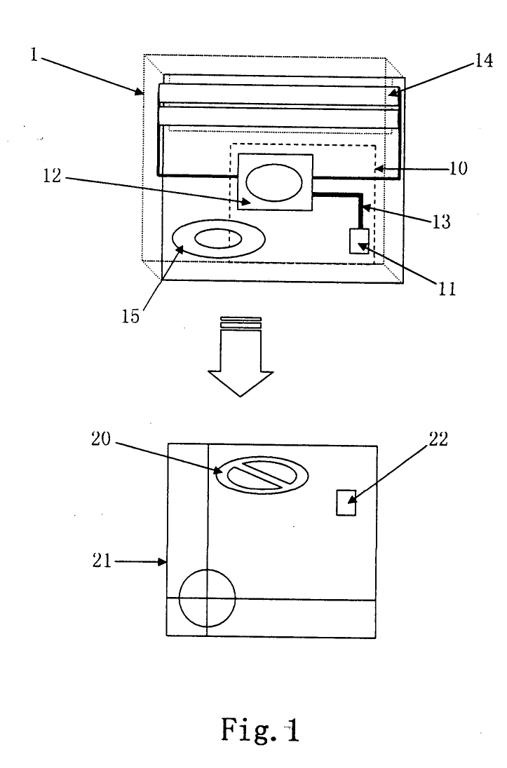

A preferred embodiment of a wirelessly-controlled detecting device in the present invention, as shown in FIG. 1, includes a one-way waterproof-ventilating outer layer 1, a signal detector 10 consisting of a first programmable IC 11 and a temperature, humidity, gas, light, pressure or electric current signal sensor 12, a soft PCB 13, a thin power supply unit 14, a wireless transmitter 15, a wireless receiver 20, a signal indicating device 21 and a second programmable IC 22 as main components combined together.

The soft PCB 13, which is able to be wound and extended, connects and positions the programmable IC 11 with the signal sensor 12 in place and is also connected with the thin power supply unit 14 and the wireless transmitter 15. The thin power supply unit 14 supplies the elements in the one-way waterproof-ventilating outer layer 1 with electricity for operation, and the flexible and extensible soft PCB 13 is able to expand a detecting range and object.

The wireless signal receiver 20 for receiving the signal transmitted by the wireless transmitter 15 is connected with the signal indicating device 21 for indicating the detection result of temperature, humidity, gas, light, pressure or electric current by means of lamplight, sounds, characters or vibration after the electrical signal is received by the wireless signal receiver 20 and transformed by the programmable IC 22.

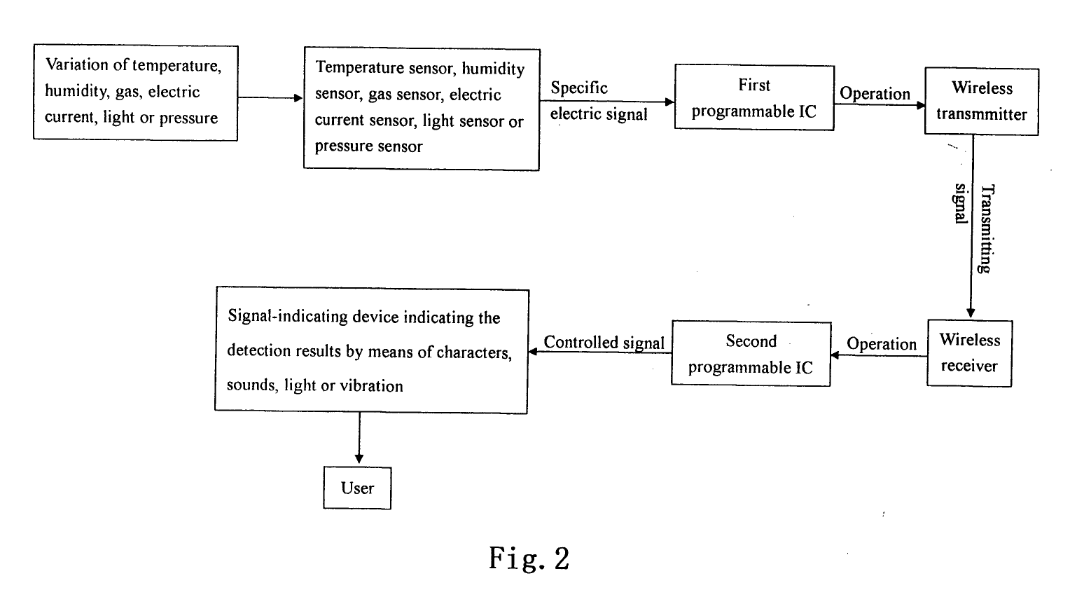

In using, referring to FIG. 2, the wireless-controlled detecting device is positioned in an environment to be detected. When the sensor 12 detects that the parameter of the temperature, or the humidity, the gas, the light, the pressure or the electric current in the environment changes, the sensor 12 will produce a specific signal and transmit it to the first programmable IC 11 for carrying out operation and producing a controlled signal, which will then be transmitted by the wireless transmitter 15 and received by the wireless signal receiver 20. Simultaneously, the controlled signal is transmitted to the second programmable IC 22 that calculates and returns it to the original signal, and then the controlled signal is outputted to the signal indicating device 21 to be shown by means of lamplight, sounds, characters or vibration to let a user know the situation and carry out supervising and controlling. Additionally, the detected results can be made into data and stored in a storage device like a computer for managing and controlling the alterations of the environment.

In the present invention, the soft PCB 13 is employed as a signal-transmission medium for the sensor 12 and the programmable IC 11, and the thin power supply unit 14 for supplying electric power is provided with needle lithium batteries, small in size. Moreover, compared with the conventional hard PCB, the soft PCB 13 is lighter, smaller in size and has higher density in wiring to cause fewer errors and also great flexibility, able to be elastically changed in shape; therefore, the wirelessly-controlled detecting device of the invention is light, thin and small in size. Moreover, for the present, the process of making the soft PCB 13 is improved to be an unleaded manufacturing process; therefore, in the process of producing a soft PCB, it is impossible to release lead or other heavy metallic materials to affect a person's health and pollute an environment. As previously mentioned, a conventional hard PCB has wires and its elements connected by welding; therefore, the wires and the elements are likely to be broken and disconnected, resulting in high fault ratio of products, but the soft PCB 13 has a circuit arranged on a flexible substratum by printing, avoiding the shortcomings of the hard PCB and able to maintain its efficacy for a long time.

Various types of sensors 12 of this invention can be respectively made into an independent module so that different sensor modules can be optionally installed for use according to different environmental conditions needed to be supervised and controlled. In other words, more than two kinds of parametric variations can be detected and compared at the same time in accordance with practical needs.

The sensors 12 employed in this invention have the following types and their applied spheres.

1. An electric current sensor and its application: The electric current sensor is placed in liquid for detecting the conductivity of the liquid and judging the variation of the ingredient in the liquid. If the liquid is pure water, which has poor conductivity and great resistance value, the electric current in the pure water to be detected is relatively weak. If the pure water is blended with a certain amount of impurities, its conductivity and the resistance value will be changed according to the concentration of the impurities dissolved in the water, and the strength of its electric current in the liquid will be changed as well. By such a principle, the electric current sensor is able to measure the changeful strength of electric current by detecting the change of the resistance value of the liquid and then judge the change of the concentration of dissolved substance in the liquid. In addition, provided with the soft PCB, and the one-way waterproof-ventilating outer layer, the wirelessly-controlled electric current sensor of this invention can be applied to pisciculture and aquaria for detecting the change of water quality and giving out warning, and also can be employed for detecting dryness of an infant's diaper, and change of the water quality and the water level of a water tower or a water tank and giving out warning.

2. A temperature sensor and its application: Provided with the soft PCB and the one-way waterproof-ventilating outer layer being light, thin, small in size and portable, the wirelessly-controlled temperature sensor of this invention, possible to sense the temperature alteration, can be fixed on an animal or a plant in a way of indirect contact for measuring a pet's and a human body's temperature, or measuring the temperature of objects or locations in the natural world, able to be used for the work of nursing the sick or taking care of pets and thus achieving the purpose of supervising and controlling multiple objects at the same time.

3. Gas sensor and its application: The gas sensor with different elements of this invention can be used for detecting the concentration and variation of smoke, natural gas, liquefied petroleum gas, isobutene, propane, carbon dioxide, organic solvent toluene, volatile organic substance, dimethylbenzene, ammonia, hydrogen-sulfide and alcohol. In addition, provided with a wireless transmitter and a wireless receiver, the gas sensors of this invention can be used in the industrial security, such as giving out warning against an environment with poisonous substances, or used as an alarm apparatus for kitchen gas and liquefied petroleum gas, able to supervise and control working surroundings.

4. Light sensor and its application: The light sensors with non-contact elements are arranged by the soft PCB and positioned at contact spots or proper locations for carrying out timely detection and reaction by means of hiding light shadows produced by movement of the objects, or by change of the strength of the surrounding light, able to be used for detection in preventing burglary, for reminding of having visitors coming, for inducing and giving out light, and for carrying out supervision and control of industrial security.

5. Humidity sensor and its application: The temperature sensor of this invention can be applied to detecting humidity. Provided with the soft PCB and one-way waterproof-ventilating outer layer, the humidity sensor of this invention can be directly installed in an environment to be detected for finding changes of its humidity. Such a humidity sensor is applicable to nursing work. For instance, the humidity sensor can be positioned in an infant's diaper for distinguishing whether the excrement is solid or liquid through changes of humidity of the diaper, or used for detecting changes of the humidity of sickbeds in order to lower the probability of causing bedsores, attaining an object of one nurse taking care of many patients at the same time.

6. A pressure sensor and its application: A pressure sensor with contact elements has circuit arranged by the soft PCB and is positioned under the surface of an object. to be detected or positioned on the contact surface. Thus, when the object is touched and pressed by someone, the pressure sensor will immediately respond to the situation, able to be used for detection in prevention of burglary, for detection of passageways and dead-angled sections, for reminding of having visitors coming and for carrying out supervision and control of industrial security.

As can be understood from the above description, this invention has the following advantages.

1. This invention uses the soft PCB as a transmission medium for the sensors and the programmable IC, and the soft PCB is light and small in size, having high density in wiring arrangement with few errors, and being of great flexibility, able to be elastically changed in shapes, able to reduce the size, prolonging the service life and lowering the fault ratio of products.

2. The soft PCB is made through an unleaded manufacturing process so it is impossible to release lead or other heavy metallic materials, elevating safety of products and bringing home the concept of environmental protection.

3. The sensors of this invention can be respectively made into an independent module so that a user can select the sensor modules he needs and install them for use by himself, facilitating carrying out detection of various environmental parameters.

4. This invention is provided with a wireless transmitter and a wireless receiver, able to economize expense in arrangement of system circuit and lower cost of products.

5. The wirelessly-controlled detecting device of this invention can be employed as a detecting device for the government industrial security unit to serve as the basis of just detection and unified control by means of wireless transmission.

While the preferred embodiment of the invention has been described above, it will be recognized and understood that various modifications may be made therein and the appended claims are intended to cover all such modifications that may fall within the spirit and scope of the invention.

1. A wirelessly-controlled detecting device comprising a one-way waterproof-ventilating outer layer, said, one-way waterproof-ventilating outer layer provided inside with a signal detector, said signal detector disposed with a first programmable IC and a sensor, said programmable IC and said sensor connected and fixed in position by a soft PCB, said soft PCB further connecting a thin power supply unit and a wireless transmitter, said wirelessly-controlled detecting device further installed with a wireless receiver, said wireless receiver connected with a second programmable IC, said second programmable IC connected with a signal indicating device.

2. The wirelessly-controlled detecting device as claimed in claim 1, wherein said sensor can be respectively made into an independent module able to be installed by a user himself.

3. The wirelessly-controlled detecting device as claimed in claim 1, wherein said sensor is a temperature sensor.

4. The wirelessly-controlled detecting device as claimed in claim 1, wherein said sensor is a humidity sensor.

5. The wirelessly-controlled detecting device as claimed in claim 1, wherein said sensor is a gas sensor.

6. The wirelessly-controlled detecting device as claimed in claim 1, wherein said sensor is an electric current sensor.

7. The wirelessly-controlled detecting device as claimed in claim 1, wherein said sensor is a pressure sensor.

8. The wirelessly-controlled detecting device as claimed in claim 1, wherein said sensor is a light sensor.
